(19) United States
(12) Patent Application Publication
(10) Pub. No.: US 2007/0277676 A1
(43) Pub. Date: Dec. 6, 2007

(54) Coffee Making Machine

(76) Inventor: Francesco Crivellin, Naviglio (IT)

Correspondence Address: NIXON & VANDERHYE, PC, 901 NORTH GLEBE ROAD, 11TH FLOOR, ARLINGTON, VA, 22203, US

(21) Appl. No.: 10/589,442

(22) PCT Filed: Feb. 25, 2004
(86) PCT No.: PCT/IT04/00087

§ 371 Date: May 10, 2007

(51) Int. Cl. A47J 31/38

(52) U.S. Cl. 99/288

(57) ABSTRACT

A coffee making machine (10) comprises a tank (34) for water, a coffee dispensing unit (44), connection means which are interposed between the tank (34) and the dispensing unit (44): the connection means comprise, in the direction of flow of the water from the tank to the dispensing unit, a manual pumping unit (46) for conveying the water from the tank to the coffee dispensing unit and a heat exchanger (48) which is provided with a pipe (50) which is interposed between the manual pumping unit (46) and the dispensing unit (44) and which extends inside a boiler (14). The pipe (50) comprises at least one portion which extends along a spiral-shaped course inside the boiler (14). The boiler (14) extends substantially vertically along a longitudinal axis (X-X). The manual pumping unit (46) and the dispensing unit (44) are arranged laterally on the boiler (14) relative to the longitudinal axis (X-X).

The present invention relates to a coffee making machine.

The present invention is particularly suitable for domestic use although it could also be used on commercial premises or in the workplace.

It is clearly necessary in the sector to obtain coffee of high quality and it is further particularly desirable to provide coffee machines in which the quality of the coffee obtained does not depend completely on the skill of the operator, whilst allowing adaptation to the different mixtures of coffee and the different needs for use.

Some of the factors which contribute to the success of the coffee are the pressure and, in particular, the temperature of the water which passes through the layer of ground coffee, as well as the infusion time.

It is known that professional machines provide the best results in relation to the quality of coffee obtained. These machines are generally provided with a boiler and the water is moved by means of an electric pump which ensures a specific pressure thereof in the circuit.

In the machines for domestic use of known type, it is generally preferred to give priority to the simplicity of use and a reduction in the dimensions over the level of performance obtained. An example of machines for domestic use is illustrated and described in EP 231 156, wherein a tank and a manual pumping unit are provided and wherein the water inside the tank is heated by placing the tank beside a heat source. This arrangement provides for the presence of an accumulator, giving priority to the need to limit the efforts of the operator in relation to the application of a pressure value so as to ensure a high level of quality of the coffee provided. Though the heating system gives priority to the simplicity of the construction, it is not able to reproduce effectively the correct temperature and pressure conditions which are necessary for coffee of high quality to be obtained.

GB 726272 discloses a coffee machine for domestic use having manual action, wherein water, which has already been heated in a boiler by means of electrical resistors, passes through a cylinder/piston unit and is directed directly through the layer of coffee below the cylinder/piston unit. The pressure and temperature conditions of the water are closely linked to each other and are substantially determined by the conditions inside the boiler. In addition, the effort of the operator in operating the lever is rather high in contrast to the pressure of the water and the force of a spring which acts on the piston. The teaching of document GB 726272 is directed towards attempts to limit this effort by balancing the pressure inside the cylinder.

The object of the present invention is to devise and provide a coffee making machine which allows the above-mentioned requirement to be met and, at the same time, allows the disadvantages mentioned with reference to the prior art to be overcome.

In greater detail, the object of the present invention is to provide a coffee making machine which is particularly suitable for domestic use but which allows coffee to be obtained whose level of quality is similar to that obtained with machines of the professional type.

This object is achieved by means of a coffee making machine according to claim 1.

Other characteristics and advantages of the coffee making machine according to the invention will become clear from the following description of preferred embodiments given purely by way of non-limiting example with reference to the appended drawings in which:

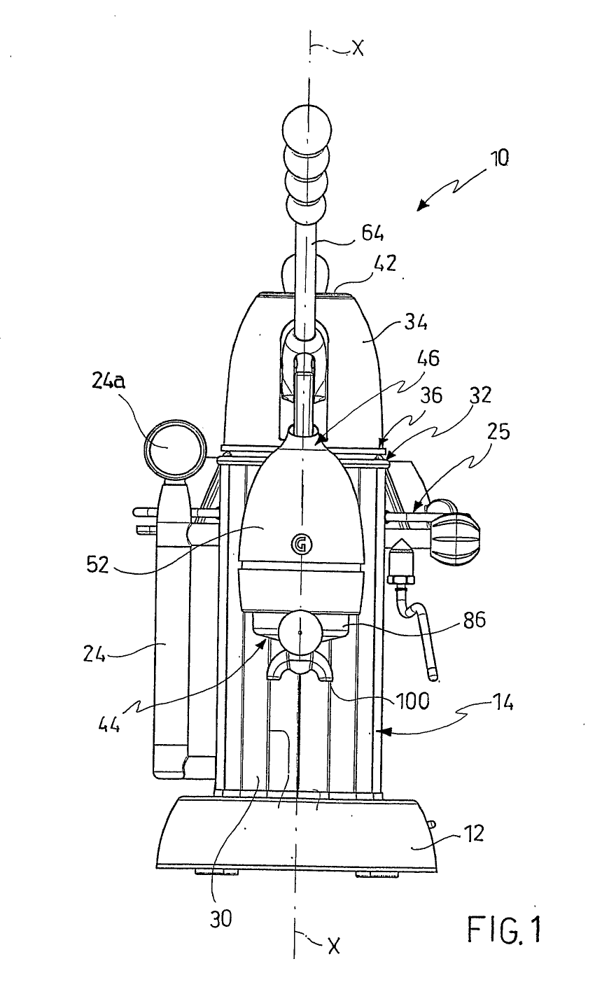

FIG. 1 is a front view of a coffee making machine according to the present invention;

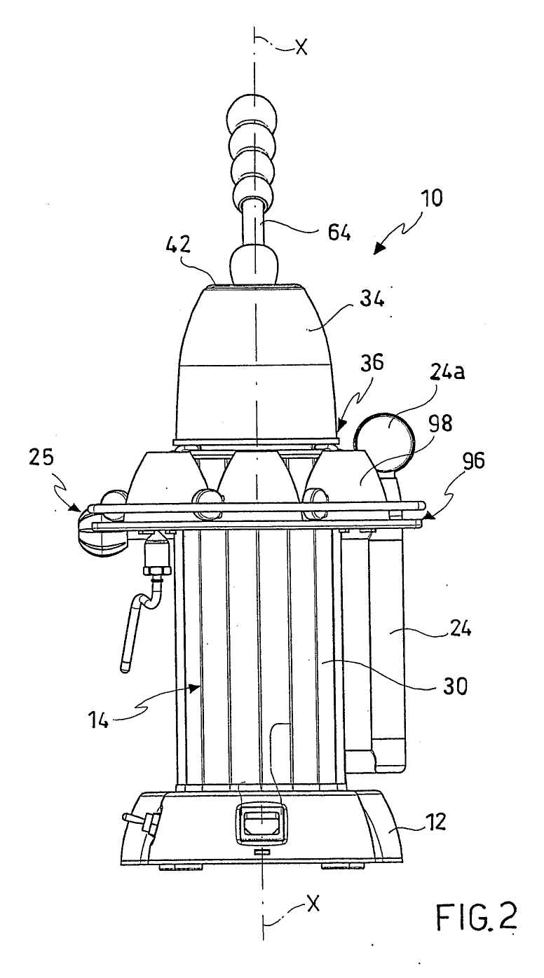

FIG. 2 is a rear view of the coffee making machine of FIG. 1;

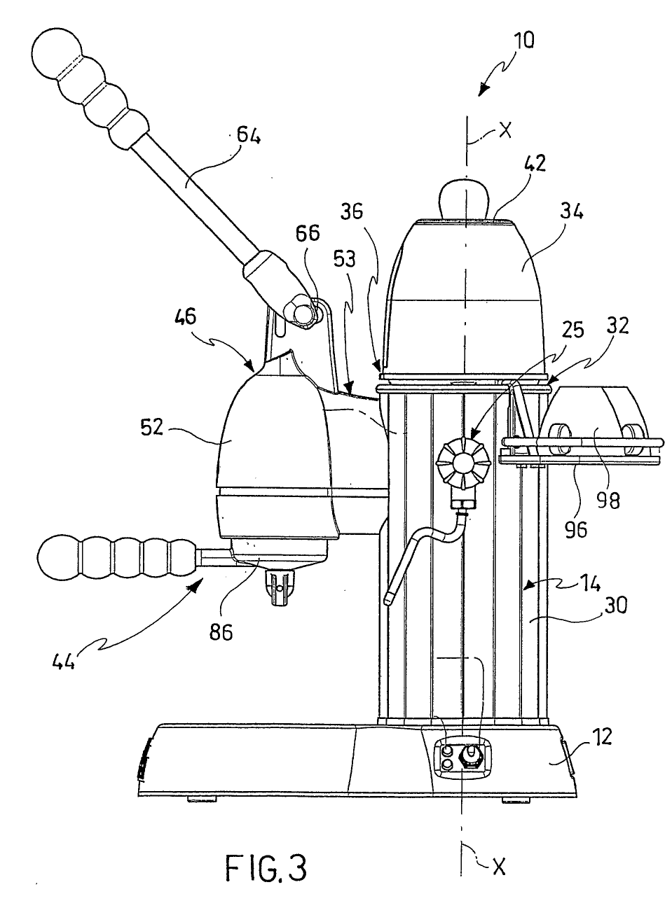

FIG. 3 is a side view of the coffee making machine of FIG. 1;

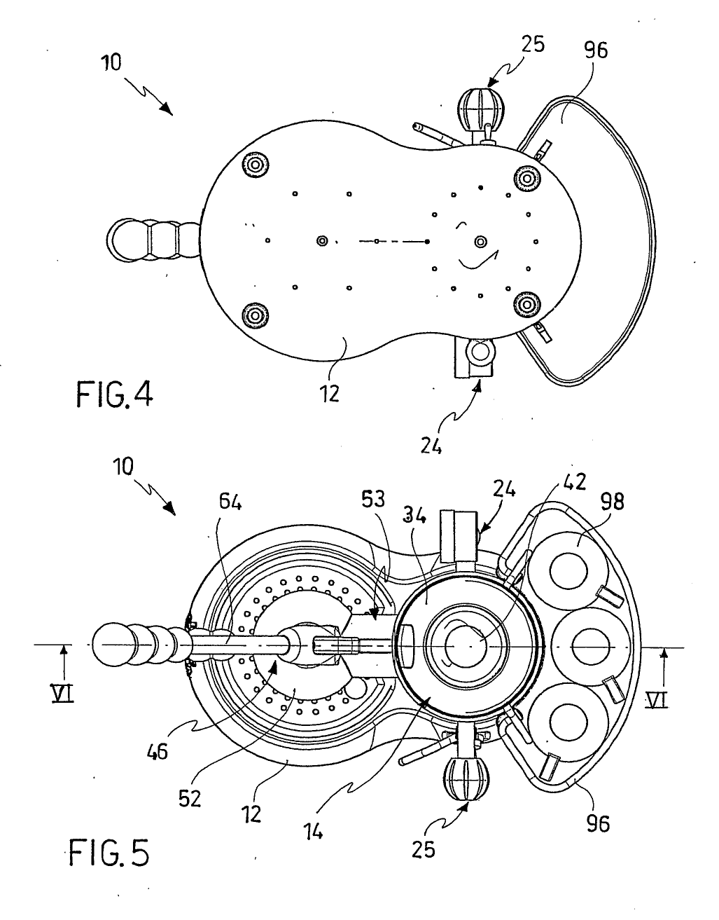

FIG. 4 is a view from below of the coffee making machine of FIG. 1;

FIG. 5 is a plan view of the coffee making machine of FIG. 1;

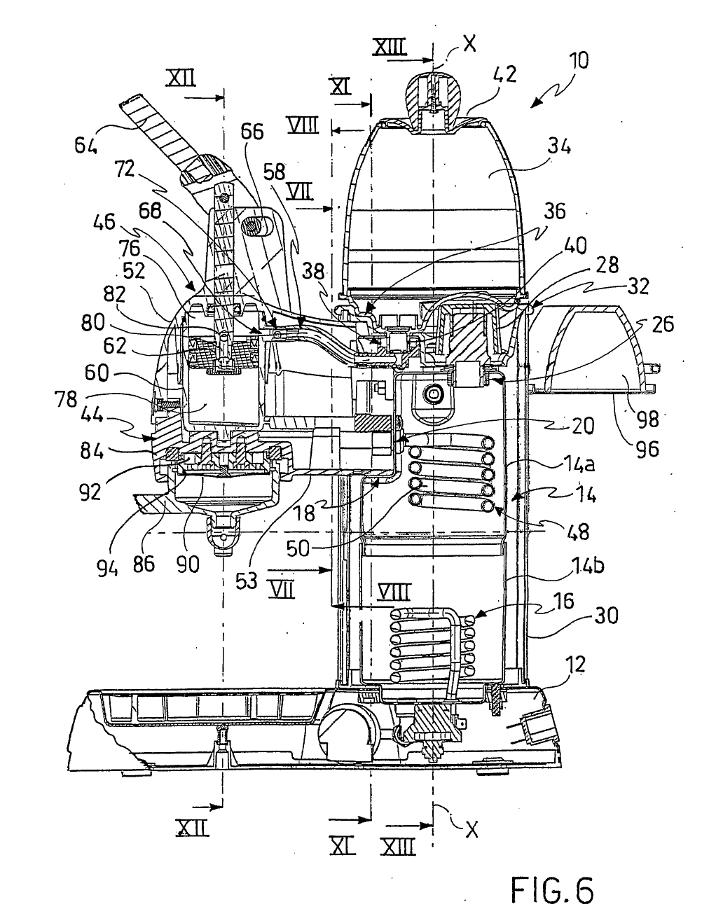

FIG. 6 is a view of the coffee making machine of FIG. 1 sectioned along line VI-VI of FIG. 5;

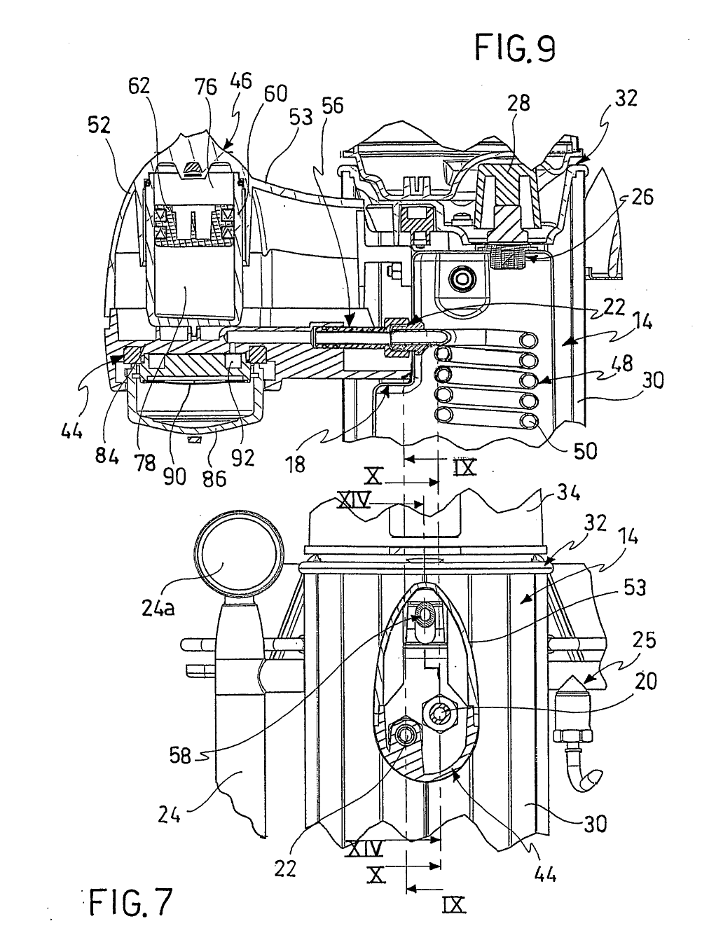

FIG. 7 is a view of a detail of the coffee making machine of FIG. 1 sectioned along line VII-VII of FIG. 6;

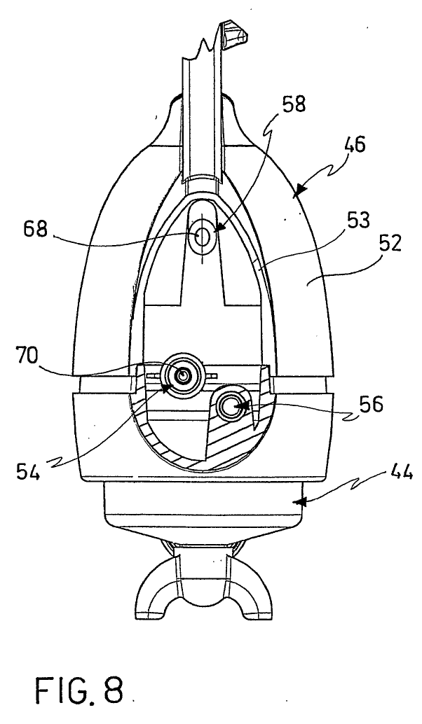

FIG. 8 is a view of the coffee making machine of FIG. 1 sectioned along line VIII-VIII of FIG. 6;

FIG. 9 is a view of a detail of the coffee making machine of FIG. 1 sectioned along line IX-IX of FIG. 7;

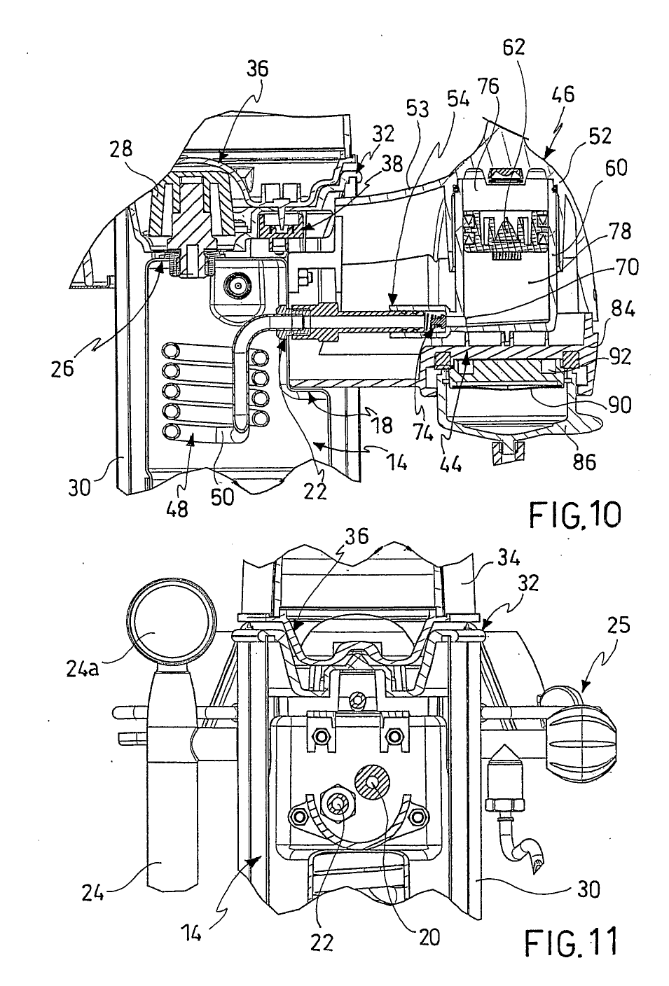

FIG. 10 is a view of a detail of the coffee making machine of FIG. 1 sectioned along line X-X of FIG. 7;

FIG. 11 is a view of a detail of the coffee making machine of FIG. 1 sectioned along line XI-XI of FIG. 6;

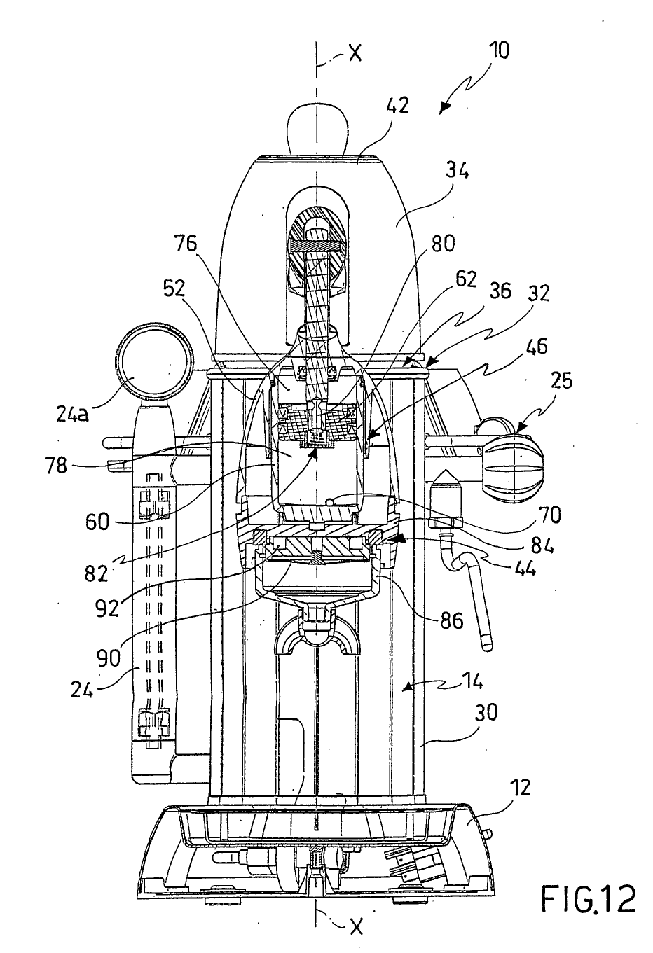

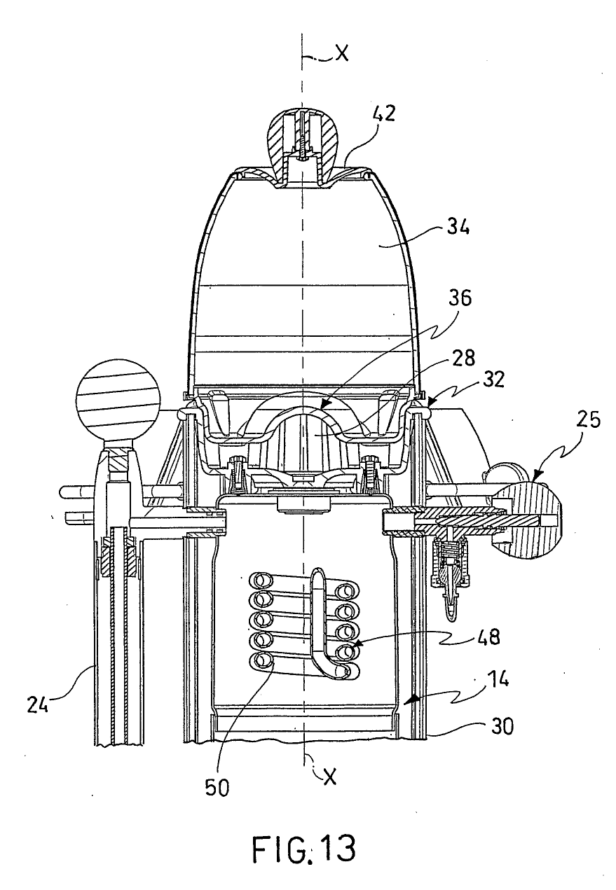

FIG. 12 is a view of the coffee making machine of FIG. 1 sectioned along line XII-XII of FIG. 6;

FIG. 13 is a view of a detail of the coffee making machine of FIG. 1 sectioned along line XIII-XIII of FIG. 6;

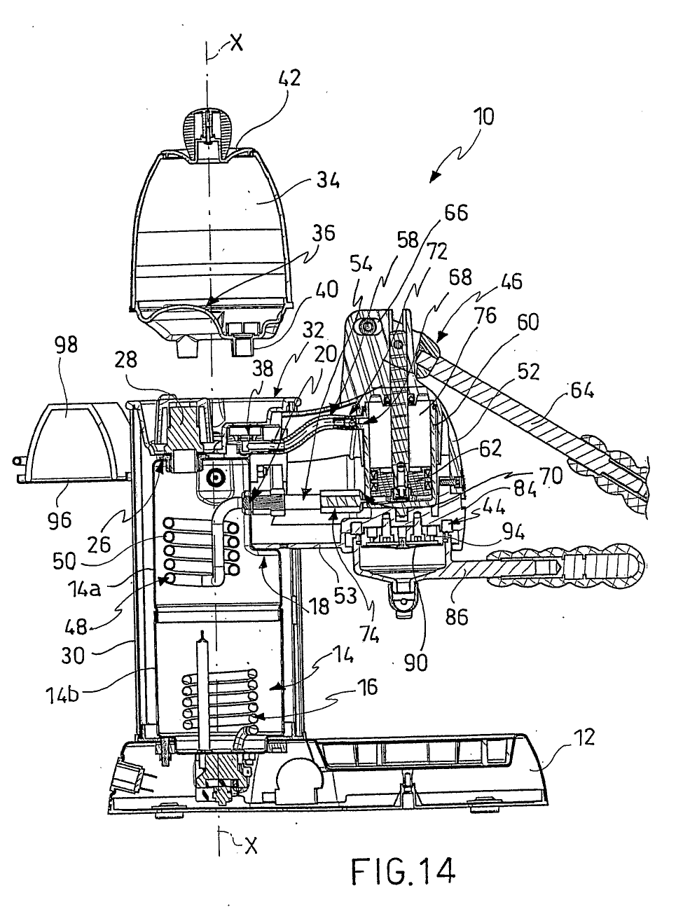

FIG. 14 is a partially exploded view of the coffee making machine of FIG. 1 sectioned along line XIV-XIV of FIG. 7;

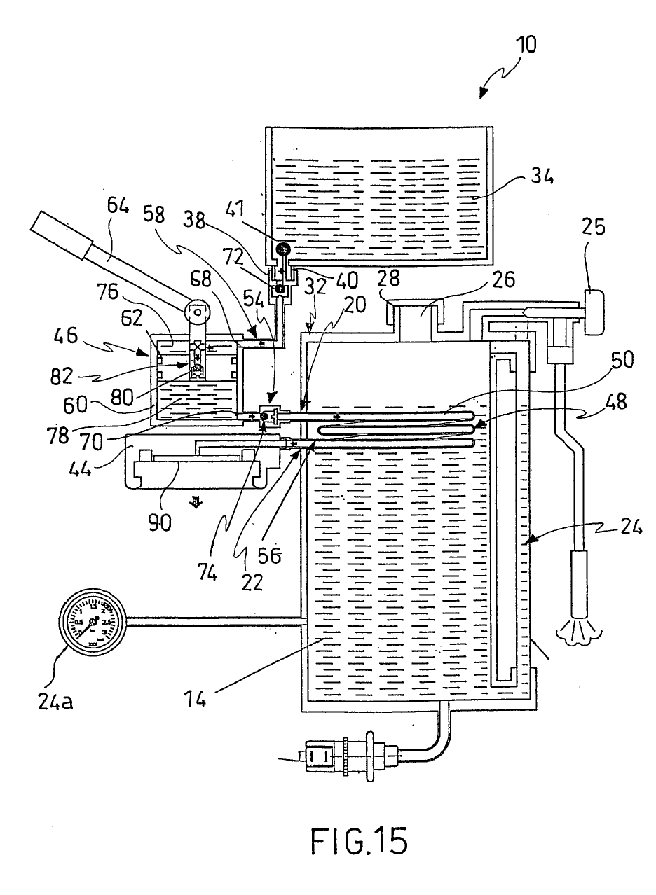

FIG. 15 is a schematic view of a coffee making machine according to the present invention.

With reference to the above-mentioned Figures, a coffee making machine, in particular but not exclusively for domestic use, is generally indicated 10.

A base of the machine is indicated 12 and is suitable for resting on a substantially horizontal plane. The base 12 has, for example, a slightly elongate form and is able to receive the electrical devices for operating the machine 10.

A boiler 14 extends from the base 12 and comprises therein heating means, for example, in the form of an electrical resistor 16. The electrical resistor advantageously extends inside the boiler at a lower portion thereof and is connected to an electrical device which is accommodated in the base 12.

According to one possible embodiment, the boiler 14 extends substantially vertically relative to the horizontal plane, on which the base 12 can be supported. In other words, the boiler 14 extends substantially perpendicularly relative to the base 12.

In greater detail, the boiler 14 extends substantially along longitudinal axis X-X which is arranged vertically. According to an advantageous embodiment, the boiler 14 has a substantially cylindrical form.

According to one possible embodiment, the boiler 14 is constructed by means of a shell in two parts 14a and 14b (FIG. 6), wherein one is fitted above the other.

According to one possible embodiment, the boiler 14 has a lateral recess 18 in the region of an upper portion thereof. The lateral recess 18 preferably faces towards a front portion of the machine 10.

The boiler 14 advantageously has a first opening 20 and a second opening 22, which are preferably formed in the region of the lateral recess 18, if present.

According to one possible embodiment, the boiler is associated with a level indicator 24, which is preferably positioned at the side of the boiler, on the outer of the machine 10. A pressure gauge 24a can further be provided. According to one possible embodiment, the boiler 14 is associated with a steam outlet 25 which is preferably positioned at the side of the boiler, on the outer of the machine 10, for example, at the side remote from the level indicator 24, if present.

An access opening 26 is preferably formed in an upper portion of the boiler and is provided with a closure plug 28.

The boiler 14 comprises an outer casing 30, which is preferably of a form substantially similar to that of the boiler proper. The outer casing extends from the base 12 to an upper portion 32. Should the access opening to the boiler be provided in an upper portion thereof, the upper portion 32 of the casing has a similar access opening for receiving the closure plug.

A tank which can contain the water for the coffee is indicated 34. The tank 34 is advantageously arranged above the boiler 14 along longitudinal axis X-X of the boiler itself.

According to one possible embodiment, the boiler 14, and in particular the upper portion 32 of the casing 30 thereof, can receive and support a lower portion 36 of the tank 34. The upper portion 32 of the boiler is advantageously a substantially concave portion which can receive the lower portion of the tank which has a substantially convex form.

The upper portion of the boiler, and in particular of the casing 30 thereof, advantageously comprises a rapid connection 38 for an outlet pipe 40 for water from the tank. A water-tight valve 41 is advantageously arranged in the outlet pipe 40.

Should the upper portion 32 of the boiler comprise the closure plug 28, the lower portion 36 of the tank 34 is advantageously shaped to receive this closure plug.

The tank 34 can contain water which is substantially at ambient temperature, and in particular has a cover 42 which can be supported on an upper access opening of the tank.

The form and the arrangement of the tank 34 are advantageously suitable for continuing the extent of the boiler in the vertical direction along axis X-X, keeping the machine compact in particular in a transverse direction. This arrangement further simplifies the structure and the form of connection means, as will be described below.

The coffee making machine 10 further comprises a coffee dispensing unit which is indicated 44 and connection means which are interposed between the tank 34 and the dispensing unit 44 in order to take water, heat it and convey it to the layer of ground coffee contained in the dispensing unit 44.

The connection means advantageously comprise, in the direction of flow of the water from the tank to the dispensing unit indicated by arrows, a manual pumping unit 46 for conveying the water from the tank to the coffee dispensing unit and a heat-exchanger 48.

The heat exchanger 48 comprises a pipe 50 which is interposed between the manual pumping unit 46 and the dispensing unit 44. This pipe 50 advantageously extends inside the boiler 14. In particular, a first end of the pipe 50 is connected to the first opening 20 of the boiler and a second end of the pipe 50 is connected to the second opening 22 of the boiler 14. The pipe 50 advantageously comprises at least one portion which extends in a spiral-shaped course inside the boiler 14.

If the boiler advantageously extends substantially vertically along longitudinal axis X-X, the manual pumping unit and the dispensing unit are arranged laterally on the boiler relative to longitudinal axis X-X. The manual pumping unit is preferably arranged above the dispensing unit relative to a horizontal plane of support of the machine.

According to one possible embodiment, the manual pumping unit and the dispensing unit define a single outer assembly which is arranged laterally on the boiler relative to longitudinal axis X-X thereof. The assembly which contains the manual pumping unit and the dispensing unit is preferably arranged laterally on the boiler by means of a casing 52 which contains connection elements 54, 56 between the manual pumping unit and the pipe 50 of the exchanger and between the pipe 50 of the exchanger and the dispensing unit, respectively.

According to one possible embodiment, the connection element 54 between the manual pumping unit and the pipe of the exchanger and the connection element 56 between the pipe of the exchanger and the dispensing unit extend transversely to longitudinal axis X-X of the boiler.

If a casing 52 is provided, it advantageously contains an additional connection element 58 between the tank and the manual pumping unit. In particular, the additional connection element 58 is completely inside the structure of the machine 10 and is interposed between the rapid connection 38 and the manual pumping unit, thereby constituting an inlet for water coming from the tank.

The casing 52 has a compact shape with a lateral extension 53 which can be arranged on the boiler. In particular, the lateral extension 53 extends inside the casing 30 which surrounds the boiler and is arranged in the region of the lateral recess 18 of the boiler 14, if present.

The manual pumping unit 46 advantageously comprises a cylinder 60 which accommodates a piston 62 which can be caused to move in translation along the cylinder by means of a lever 64. In greater detail, the cylinder 60 is arranged inside the casing 52 and the lever 64 has a fulcrum on an outer portion of the casing 52 and is hinged at one end of the extent of the piston. The lever 64 advantageously has a fulcrum on the casing 52 by means of a hole 66 which is formed in the portion of the casing itself. In addition, the lever 64 is supported on the casing 52 in such a manner that, by the free end of the lever 64 being lifted, the piston 62 is translated upwards inside the cylinder.

The cylinder 60 is provided with an inlet 68, which is placed in communication with the tank, and an outlet 70 which is placed in communication with the exchanger, in particular with the pipe 50 of the exchanger.

A non-return valve 72 is advantageously arranged between the tank and the inlet of the cylinder, preferably along the connection element 54. A non-return valve 74 is further arranged between the outlet of the cylinder and the exchanger, preferably in the region of the connection element 56. The two non-return valves allow the passage of water in the direction from the tank to the cylinder and to the exchanger, as illustrated by the arrows.

The piston 62 is advantageously suitable for dividing the cylinder into a first chamber 76, in communication with the inlet 68 of the cylinder, and a second chamber 78, in communication with the outlet 70 of the cylinder. The piston 62 further comprises a duct 80 which is suitable for placing the first chamber and second chamber in communication.

A non-return valve 82 is advantageously arranged inside the duct 80 of the piston and allows the passage of water in the direction from the first chamber to the second chamber.

The manual pumping unit and the dispensing unit, whilst being positioned one above the other, are not in direct communication so that the water is not thrust directly from the cylinder to the dispensing unit. Instead, it is conveyed beforehand to the heat exchanger so that it reaches the correct temperature suitable for making optimum coffee.

According to one possible embodiment, the dispensing unit comprises a water distribution portion 84 which is arranged on the machine 10 and in particular on the casing 52 which accommodates the cylinder. The dispensing unit further comprises a container element 86 for the layer of ground coffee which is arranged at the end of a lever 88 and which is suitable for being fixed to the water distribution portion. The water distribution portion 84 is provided with a dispensing surface 90 which can face towards the layer of ground coffee. The distribution portion comprises a distribution pipe 92 in order to convey water to at least one opening 94 of the dispensing surface. According to one possible embodiment, the distribution pipe 92 is at least partially annular relative to the dispensing surface. The connection element 56 is further arranged substantially parallel with the dispensing surface, and is interposed between the exchanger and the distribution pipe. The connection element is advantageously engaged in the dispensing unit.

According to one possible embodiment, the casing 30 of the boiler has a support 96 for cups 98 which extends transversely to axis X-X.

The operation of a coffee making machine according to the present invention will be described below.

FIG. 6 shows the rest state of the coffee making machine 10, wherein the piston 62 is in the raised state thereof, as is the lever 64. Water is present inside the tank 34, along the additional connection pipe 58, in the first chamber and in the second chamber of the cylinder 60, along the connection pipe 54, in the pipe 50 of the exchanger and in the connection pipe 56.

By the lever 64 being lowered manually in order to bring it from the position of FIG. 6 to the position of FIG. 14, the piston carries out the outward path thereof from the raised position to the lowered position.

The water contained in the second chamber 78 of the cylinder is conveyed along the pipe 50 in such a manner that the water contained inside the pipe 50 reaches the distribution pipe 92 and from there the layer of coffee by being discharged from the nozzles 100.

The reduced pressure inside the first chamber 76 draws water from the tank through the non-return valve 72.

When the lever 64 is being lowered, the operator must contend with only the resistance which the water encounters along the path thereof, in particular through the layer of coffee. Therefore, the operator can control the time for which the lever is to be lowered and the effort which is intended to be applied thereto, whilst the temperature of the water is advantageously determined by the time spent in the heat exchanger.

During the return travel, the piston is raised by means of the lever 64, which is itself raised from the position of FIG. 14 to the position of FIG. 6. The water contained in the cylinder 60, which is isolated by means of the two non-return valves 72 and 74, is distributed between the two chambers so that the water in the first chamber 76 passes into the second chamber 78 through the pipe 80 and the non-return valve 82. At the end of the return travel, the piston and the lever are once more in the rest state, ready to convey a further quantity of water into the pipe of the exchanger and, from there, to the dispensing unit.

The coffee making machine 10 keeps dimensions small, above all in the transverse direction, and allows high-quality coffee to be made. In fact, the unusual combination of a manual pumping unit and an exchanger unit renders the reaching of a specific water temperature unconstrained by the pressure which it is necessary to apply so that the water passes through the layer of coffee.

The temperature of the water is advantageously determined by the travel along the pipe 50 inside the boiler, whilst the application of a force by the operator allows the mixture of water/coffee to be discharged in accordance with the desired characteristics thereof, for example, according to the type of mixture.

The original combination of a manual pumping unit and a heat exchanger unit allows water at ambient temperature to be used, avoiding the problems connected with a pressurised receiver. The boiler has the sole objective of heating the water in the pipe 50, therefore avoiding the necessity for regular refills. In addition, the structure of the manual pumping unit is greatly simplified and does not have to be directly connected to the boiler and therefore it is not necessary to produce a single water-tight compartment.

Furthermore, since the water pressure for the coffee is substantially unconstrained by that inside the boiler, the manual pumping unit can advantageously be operated with variable efforts even of limited magnitude without requiring the provision of resilient elements.

The machine according to the present invention further has great compactness owing to the original arrangement of the tank which is directly supported on the upper portion of the boiler to form a structure extending substantially vertically. The advantageous provision of the manual pumping unit above the dispensing unit, without the need for a direct passage of water from one to the other, also contributes substantially to keeping the structure compact.

As schematically illustrated in FIG. 15, for example, the water is compelled to follow a tortuous route between the tank, the manual pumping unit, the heat exchanger and the dispensing unit. This also allows, whilst a substantially upright shape is maintained, limitation of the dimensions along axis X-X by keeping the manual pumping unit and the dispensing unit at the side of the tank. This advantage is further supplemented by the provision of connection pipes which are transverse to axis of development X-X of the machine.

This manual pumping unit contributes to the simplification of the operation and the structure of the machine owing to the original provision of a piston which is suitable for dividing the cylinder into two chambers which are connected by means of a pipe inside the piston itself. This provision further contributes to limiting the efforts of the operator who has to contend only with the resistance encountered by the water without the need for springs or resilient elements.

The dispensing unit is advantageously arranged to receive the water from the pipe of the exchanger in a direction transverse to axis X-X of the machine. In this case, the provision of a distribution pipe and in particular of an annular distribution pipe allows water to be directed from the connection pipe transversely to the machine to the dispensing surface.

It will be appreciated that it is possible to provide variants and/or additional features relative to those described and illustrated above.

In order to satisfy contingent and specific requirements, a person skilled in the art may apply to the above-described embodiments of the coffee making machine many modifications, adaptations and replacements of elements with other functionally equivalent elements without; however, departing from the scope of the appended claims.

1-22. (canceled)

23. A coffee making machine (10) which comprises:
a tank (34) for water,
a coffee dispensing unit (44),
connection means which are interposed between the tank (34) and the dispensing unit (44) and which comprise, in the direction of flow of the water from the tank to the dispensing unit, a manual pumping unit (46) for conveying the water from the tank to the coffee dispensing unit and a heat exchanger (48).

24. A coffee making machine according to claim 23, wherein the heat exchanger (48) comprises a pipe (50) which is interposed between the manual pumping unit (46) and the dispensing unit (44), the pipe extending inside a boiler (14).

25. A coffee making machine according to claim 24, wherein the pipe (50) comprises at least one portion which extends along a spiral-shaped course inside the boiler (14).

26. A coffee making machine according to claim 24, wherein the boiler (14) extends substantially vertically along a longitudinal axis (X-X) and wherein the manual pumping unit (46) and the dispensing unit (44) are arranged laterally on the boiler (14) relative to the longitudinal axis (X-X).

27. A coffee making machine according to claim 26, wherein the manual pumping unit (46) is arranged above the dispensing unit (44) relative to a horizontal plane of support of the machine.

28. A coffee making machine according to claim 27, wherein the manual pumping unit (46) and the dispensing unit (44) define a single outer assembly which is arranged laterally on the boiler (14) relative to the longitudinal axis (X-X) thereof.

29. A coffee making machine according to claim 28, wherein the assembly which contains the manual pumping unit (46) and the dispensing unit (44) is arranged laterally on the boiler (14) by means of a casing (52) which contains connection elements (54, 56) between the manual pumping unit (46) and the pipe (50) of the exchanger (48) and between the pipe of the exchanger and the dispensing unit (44).

30. A coffee making machine according to claim 29, wherein the connection elements (54, 56) between the manual pumping unit and the pipe of the exchanger and between the pipe of the exchanger and the dispensing unit extend transversely to the longitudinal axis (X-X) of the boiler.

31. A coffee making machine according to claim 29, wherein the casing (52) contains an additional connection element (58) between the tank and the manual pumping unit.

32. A coffee making machine according to claim 26, wherein the tank (34) is arranged above the boiler (14) along the longitudinal axis (X-X).

33. A coffee making machine according to claim 32, wherein an upper portion (32) of the boiler (14) can receive and support a lower portion (36) of the tank (34).

34. A coffee making machine according to claim 33, wherein the upper portion (32) of the boiler (14) is a substantially concave portion which can receive the lower portion (36) of the tank (34) which has a substantially convex form.

35. A coffee making machine according to claim 33, wherein the upper portion (32) of the boiler (14) comprises a rapid connection (38) for an outlet pipe (40) for water from the tank (34), the rapid connection (38) being connected to the manual pumping unit (46).

36. A coffee making machine according to claim 33, wherein the upper portion (32) of the boiler (14) comprises an access opening (26) to the boiler which is provided with a closure plug (28), and wherein the lower portion (36) of the tank is shaped to receive the closure plug (28).

37. A coffee making machine according to claim 23, wherein the manual pumping unit (46) comprises a cylinder (60) which accommodates a piston (62) which can be caused to move in translation along the cylinder by means of a lever (64), and wherein the cylinder comprises an inlet (68) which is placed in communication with the tank (34) and an outlet (70) which is placed in communication with the exchanger (48).

38. A coffee making machine according to claim 37, wherein a non-return valve (72) is arranged between the tank (34) and the inlet (68) of the cylinder (60) and a non-return valve (74) is arranged between the outlet (70) of the cylinder (60) and the exchanger (48), the non-return valves being able to allow the passage of water in the direction from the tank to the cylinder and to the exchanger.

39. A coffee making machine according to claim 37, wherein the piston (62) is suitable for dividing the cylinder (60) into a first chamber (76), in communication with the inlet (68), and a second chamber (78), in communication with the outlet (70), the piston comprising a duct (80) which is suitable for placing the first chamber and second chamber in communication.

40. A coffee making machine according to claim 39, wherein a non-return valve (82) is arranged inside the duct (80) of the piston (62) and can allow the passage of water in the direction from the first chamber to the second chamber.

41. A coffee making machine according to claim 23, wherein the tank (34) can contain water which is substantially at ambient temperature.

42. A coffee making machine according to claim 23, wherein the dispensing unit comprises a water distribution portion (84) which is provided with a dispensing surface (90) which can face a layer of coffee, the distribution portion comprising a distribution pipe (92) in order to convey water to at least one opening (94) of the dispensing surface (90).

43. A coffee making machine according to claim 42, wherein a connection element (56) is provided substantially parallel with the dispensing surface (90), which connection element (56) is interposed between the exchanger (48) and the distribution pipe (92).

44. A coffee making machine according to claim 43, wherein the connection element (56) is engaged in the dispensing unit.
